(19) United States
(12) Patent Application Publication
(10) Pub. No.: US 2018/0260622 A1
(43) Pub. Date: Sep. 13, 2018

(54) SYSTEM AND METHOD IDENTIFICATION OF ITEMS IN ELECTRONIC DOCUMENTS

(71) Applicant: Vatbox, Ltd., Herzeliya (IL)

(72) Inventors: Isaac SAFT, Kfar Neter (IL); Noam GUZMAN, Ramat Hasharon (IL)

(73) Assignee: Vatbox, Ltd., Herzeliya (IL)

(21) Appl. No.: 15/913,582

(22) Filed: Mar. 6, 2018

Related U.S. Application Data
(63) Continuation of application No. PCT/US2016/050381, filed on Sep. 6, 2016.
(60) Provisional application No. 62/215,011, filed on Sep. 6, 2015.

(51) Int. Cl. G06K 9/00; G06Q 40/00

(52) U.S. Cl. CPC G06K 9/00456; G06K 2209/01; G06Q 40/123

(57) ABSTRACT

A system and method for identifying items indicated in electronic documents are provided. The method includes obtaining an electronic document, the electronic document; analyzing, via an optical recognition processor, the electronic document; identifying, based on the optical recognition processor analysis, a plurality of item indicators of the electronic document; and determining, based on the identified plurality of item indicators, at least one item indicated in the electronic document.

### CROSS-REFERENCE TO RELATED APPLICATIONS

This application is a continuation of International Patent Application No. PCT/US2016/050381 filed on Sep. 6, 2016, now pending, which claims the benefit of U.S. Provisional Application No. 62/215,011 filed on Sep. 6, 2015. The contents of the above-noted applications are hereby incorporated by reference.

### TECHNICAL FIELD

The present disclosure relates generally to image-based identification, and more specifically to identifying items listed in images.

### BACKGROUND

The Value-Added Tax (VAT) is a broadly based consumption tax assessed on the value added to goods and services. A particular VAT applies to most goods and services that are bought or sold within a given country. When a person travels abroad and makes a purchase that requires paying a VAT, that person may be entitled to a subsequent refund of the VAT for the purchase. Other taxes applied to purchases may similarly be refunded under particular circumstances. Further, sellers may offer rebates for purchases of products sold in certain locations and under particular circumstances. Such refunds of the purchase price may be reclaimed by following procedures established by the refunding entity.

The laws and regulations of many countries allow foreign travelers the right for reimbursement or a refund of certain taxes such as, e.g., VATs paid for goods and services abroad. As such laws and regulations are different from one country to another, determination of the actual VAT refunds that one is entitled to receive often requires that the seeker of the refund possess a vast amount of knowledge in the area of tax laws abroad. Moreover, travelers may seek refunds for VATs when they are not entitled to such refunds, thereby spending time and effort on a fruitless endeavor. Further, availability of the VAT refund may vary based on the type of purchase made and the presence of a qualified VAT receipt.

One procedure to request a refund is to physically approach a customs official at, for example, an airport, fill out a form, and file the original receipts respective of the expenses incurred during the visit. This procedure should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

As travelers are not familiar with specific laws and regulations for claiming a refund, the travelers may submit a claim for a refund even though they are not eligible. This procedure further unnecessarily wastes time if the traveler ultimately learns that he or she is not entitled to any refund.

Furthermore, due to the hassles associated with claiming refunds and, in particular, VAT refunds, customers may not be motivated to seek such refunds. Particularly with respect to potentially large refunds, properly managed refunding platforms may be crucial for saving money. As an example, a VAT refunding platform may be important to large enterprises requiring their employees to travel for business purposes. When employees are not given incentives for obtaining the proper refunds, they are much less likely to successfully complete the refund process.

Additionally, manual review of invoices and other documents indicating transaction information frequently leads to difficulties for customers. Such difficulties may include any human errors made while reviewing the invoices. Further, if an invoice is in another language, the customer may face challenges in interpreting the information contained therein unless he or she uses a translator, which further introduces the possibility of error.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for identifying items indicated in electronic documents. The method includes obtaining an electronic document, the electronic document; analyzing, via an optical recognition processor, the electronic document; identifying, based on the optical recognition processor analysis, a plurality of item indicators of the electronic document; and determining, based on the identified plurality of item indicators, at least one item indicated in the electronic document.

Some embodiments disclosed herein also include a non-transitory computer-readable medium having stored thereon instructions for causing one or more processing units to execute a method, the method comprising: obtaining an electronic document, the electronic document; analyzing, via an optical recognition processor, the electronic document; identifying, based on the optical recognition processor analysis, a plurality of item indicators of the electronic document; and determining, based on the identified plurality of item indicators, at least one item indicated in the electronic document.

Some embodiments disclosed herein also include a system for identifying items indicated in electronic documents. The system comprises: an optical recognition processor; a processing circuitry and a memory, the memory containing instructions that, when executed by the processing circuitry, configure the system to: obtain an electronic document, the electronic document; analyze, via the optical recognition processor, the electronic document; identify, based on the optical recognition processor analysis, a plurality of item indicators of the electronic document; and determine, based on the identified plurality of item indicators, at least one item indicated in the electronic document

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for identifying items in an electronic document according to an embodiment.

FIGS. 3A and 3B show example invoices including pluralities of items.

FIG. 4 is a block diagram of a server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Some example disclosed embodiments include a method and system for identifying items in electronic documents. In an embodiment, an electronic document (e.g., an image file) is obtained. A plurality of item indicators is identified in the electronic document. The item indicators are analyzed using computer vision, and each item indicated in the electronic document is identified based on the analysis. In a further embodiment, based on the identified items and the item indicators, a value-added tax amount charged for each item is determined. In yet a further embodiment, it may be determined whether a value-added tax reclaim is applicable.

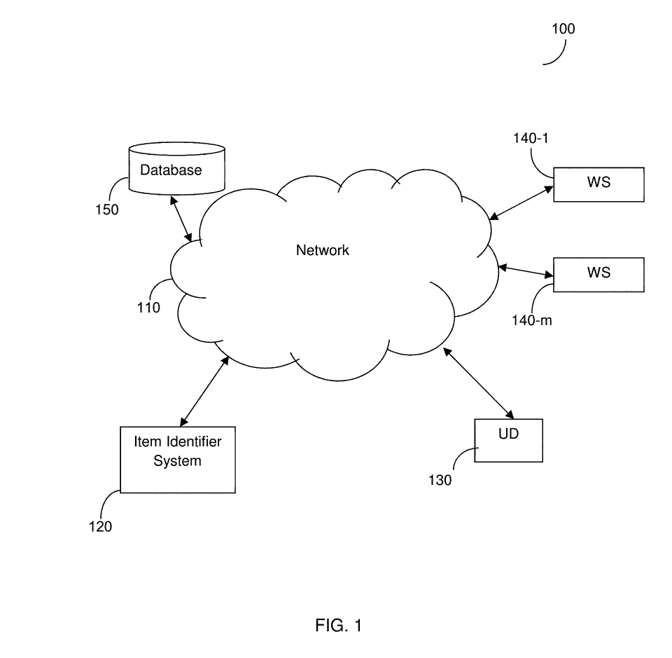

FIG. 1 shows an example network diagram 100 utilized to describe the various disclosed embodiments. In an embodiment, the network diagram 100 includes a network 110 communicatively connected to an item identifier system 120, user device (UD) 130, a plurality of web sources (WSs) 140-1 through 140-m (hereinafter referred to individually as web sources 140 and collectively as web sources 140, merely for simplicity purposes), and a database 150. The network 110 may be, but is not limited to, a wireless, cellular or wired network, a local area network (LAN), a wide area network (WAN), a metro area network (MAN), the Internet, the worldwide web (WWW), similar networks, and any combination thereof. Each web source 140 may be owned or operated by, e.g., a tax authority, a VAT refund agent, a governmental entity, a business, or any other entity having information related to the analysis of the item indicators.

The user device 130 may be, but is not limited to, a personal computer, a laptop, a tablet computer, a smartphone, a wearable computing device, or any other device capable of capturing, storing, and sending unstructured data sets. As a non-limiting example, the user device 130 may be a smart phone including a camera. The user device 130 is typically utilized by an enterprise employee or any other entity seeking to have items identified in electronic documents captured by, e.g., a camera of the user device 130. The identified items may be needed for, e.g., accounting purposes, such as for analytics, VAT reclaims, and the like.

An example electronic document captured via the user device 130 may be an image showing a receipt in which various items that were purchased or otherwise selected are indicated. For example, the items may include, but are not limited to, accommodations (e.g., travel or lodging), food, beverages, entertainment, communications (e.g., phone or Internet charges), goods (e.g., clothes, toys, electronics, furniture, etc.), combinations thereof, and the like. In different geographic territories, different value-added tax (VAT) values may be applied to different types of items. For example, in a particular country, a VAT of 18% may be charged for food and a VAT of 20% may be charged for beverages.

In an embodiment, the item identifier system 120 is configured to identify at least characters and other visual features in data and, in particular, in unstructured data. In an embodiment, the item identifier system 120 is configured to obtain an image (e.g., image of expense receipts) or any other unstructured data set from, e.g., the user device 130 or one of the web sources 140. For example, a user of the user device 130 may take a picture of a receipt via a camera of the user device 130 and send the picture to the item identifier system 120. The item identifier system 120 is configured to analyze the unstructured data set.

The analysis by the item identifier system 120 may include, but is not limited to, recognizing elements shown in the unstructured data set via computer vision techniques. Such computer vision techniques may further include image recognition, pattern recognition, signal processing, character recognition, and the like. In a further embodiment, the item identifier system 120 may be configured to identify a plurality of item indicators in the electronic document. The item indicators may be identified via the computer vision analysis. Each item indicator is a textual representation of information related to one of the items of the electronic document such as, but not limited to, business information of a business from which the item was purchased (e.g., name, address, business registration number, type of currency accepted by the business, etc.), transaction information related to a transaction involving the item (e.g., payment method, date of transaction, invoice or receipt number, amount paid etc.), item identifying information (e.g., item name, item identification number, etc.), a combination thereof, and the like.

In a further embodiment, the item identifier system 120 may be configured to identify a threshold number of item indicators, a threshold set of item indicators, or both, before the analysis. In yet a further embodiment, if the threshold number of item indicators is not identified, the item identifier system 120 may be configured to return an error notification or to query at least one of the web sources 140 for more item indicators related to the transaction. Analyzing item indicators meeting a threshold conserves computing resources by only analyzing the item indicators when the analysis will likely yield sufficient information and may further conserve computing resources by only analyzing a minimal number of item identifiers needed to accurately represent the items. The threshold number and set may be predetermined.

Based on the analysis of the identified item indicators, the item identifier system 120 is configured to identify each item indicated in the electronic document. In an embodiment, identifying the items indicated in the electronic document may include, but is not limited to, querying at least one of the web sources 140. The query may be based on the item indicators.

In a further embodiment, the item identifier system 120 may be configured to determine information related to value-added taxes (VATs) applied to a purchase of the item. In yet a further embodiment, based on the identified items and their respective purchase prices, the item identifier system 120 may be configured to determine an amount of VAT applied to each item. To this end, the item identifier system 120 may be configured to query one or more of the web sources 140 based on the item identifiers to determine a VAT value applied to the items purchased. Alternatively or collectively, the item identifier system 120 may be configured to query one or more of the web sources 140 to determine whether a VAT reclaim can be granted based on, e.g., a type of each item purchased, whether the purchase is a business expense, and the like.

As a non-limiting example, item indicators including the brand name “Jack Daniels®” and a price of $19 are identified. Based on the item indicators, the item identifier system 120 queries the web sources 140 and determines, based on the response to the query, that the item is an alcoholic beverage, specifically, a bottle of whiskey. As a further example, the item identifier system 120 queries the web sources 140 based on the item identifiers to determine a VAT value applied to each item and whether a VAT reclaim can be granted for the purchased items. These VAT values and indication of whether a VAT reclaim can be granted may be utilized to, e.g., determine whether a VAT reclaim request should be submitted and automatically requesting a VAT reclaim as describe in, e.g., U.S. patent application Ser. No. 14/575,115 filed on Dec. 18, 2014, now pending, the contents of which are hereby incorporated by reference for all that they contain.

It should be understood that the embodiments disclosed herein are not limited to the specific architecture illustrated in FIG. 1, and other architectures may be equally used without departing from the scope of the disclosed embodiments. Specifically, the item identifier system 120 may reside in a cloud computing platform, a datacenter, and the like. Moreover, in an embodiment, there may be a plurality of servers operating as described hereinabove and configured to either have one as a standby, to share the load between them, or to split the functions between them. Additionally, in some embodiments, the optical character recognition processor 126 may be integrated in the item identifier system 120. Further, the embodiment discussed with respect to FIG. 1 is described as interacting with only one enterprise resource planning system 160 merely for simplicity purposes and without limitations on the disclosure. Data from additional enterprise resource planning systems may be verified by the item identifier system 120 without departing from the scope of the disclosed embodiments.

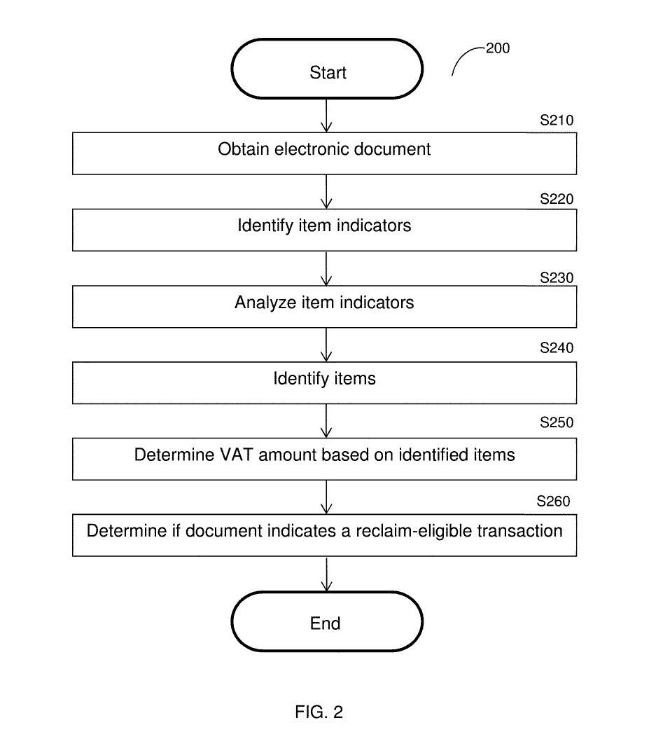

FIG. 2 is an example flowchart 200 illustrating a method for identifying items indicated in an electronic document according to an embodiment. In an embodiment, the method may be performed by an item identifier system (e.g., the item identifier system 120).

At S210, an electronic document is obtained. The obtained electronic document may be, e.g., received from a user device (e.g. the user device 130), retrieved from a web source (e.g., the web source 140), and the like. The electronic document may be, but is not limited to, an image showing a receipt indicating one or more items that were purchased.

At S220, item indicators in the electronic document are identified. The item indicators may be, but are not limited to, textual representations of information related to the items, to a transaction involving the items, a combination thereof, and the like. In an embodiment, S220 may include using computer vision techniques to identify characters in the electronic document and determining, based on the characters, the item indicators.

At S230, the item indicators are analyzed. The analysis may include, but is not limited to, determining a type of each item indicator, correlating item identifiers related to the same item, a combination thereof, and the like.

At S240, based on the analysis, the items indicated by the electronic document are identified. In an embodiment, S240 includes querying one or more web sources (e.g., the web sources 140) and determining, based on responses to the queries, the items.

At optional S250, a VAT amount charged for each item indicated in the electronic document is determined. In an embodiment, S250 may include querying one or more web sources (e.g., the web sources 140) and determining, based on responses to the queries, the VAT amounts. The VAT amounts may be determined further based on a type of each item and a price of each item as noted by, e.g., the item indicators.

At optional S260, it may be determined, based on the item indicators and the identified items, whether a purchase of each item is eligible for a VAT reclaim. Determining eligibility for VAT reclaims is described further in the above-noted Ser. No. 14/575,115 application, which is hereby incorporated by reference for all that it contains.

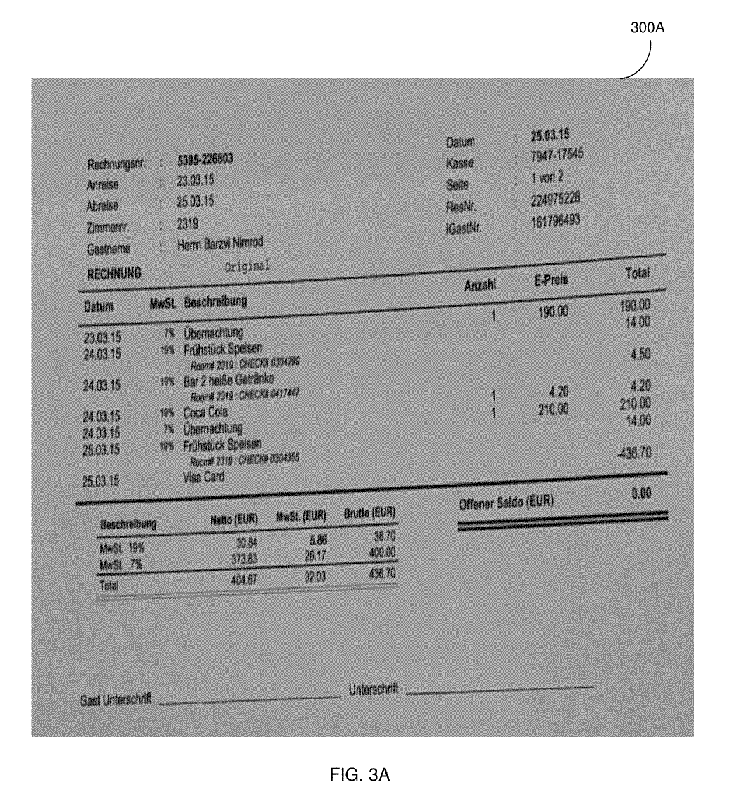

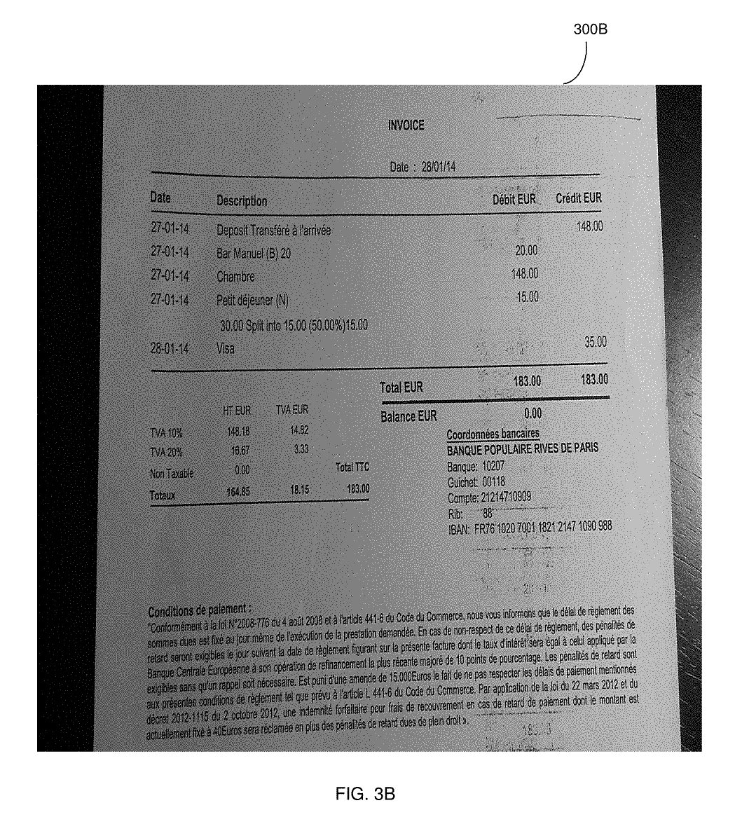

FIGS. 3A and 3B show example electronic documents 300A and 300B in which items may be identified. The example electronic documents 300A and 300B are images of invoices in which items purchased by a customer are listed. The electronic documents 300A and 300B can be analyzed using optical character recognition techniques to identify characters therein, which can be subsequently utilized to determine item indicators for identifying the purchased items.

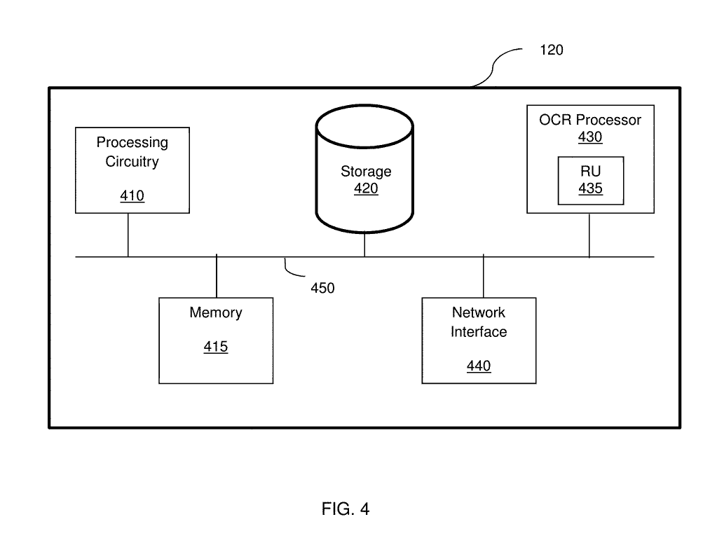

FIG. 4 is an example block diagram of the item identifier system 120 implemented according to one embodiment. The item identifier system 120 includes a processing circuitry 410 coupled to a memory 415, a storage 420, an optical character recognition (OCR) processor 430, and a network interface 440. In an embodiment, the components of the item identifier system 120 may be communicatively connected via a bus 450.

The processing circuitry 122 may comprise or be a component of a processor (not shown) or an array of processors coupled to the memory 124. Specifically, the processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 415 may be volatile (e.g., RAM, etc.), non-volatile (e.g., ROM, flash memory, etc.), or a combination thereof. In one configuration, computer readable instructions to implement one or more embodiments disclosed herein may be stored in the storage 420.

In another embodiment, the memory 415 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 410 to perform the various processes described herein. Specifically, the instructions, when executed, cause the processing circuitry 410 to perform an on-demand authorization of access to protected resources, as discussed hereinabove.

The storage 420 may be magnetic storage, optical storage, and the like, and may be realized, for example, as flash memory or other memory technology, CD-ROM, Digital Versatile Disks (DVDs), or any other medium which can be used to store the desired information.

The OCR processor 430 may include, but is not limited to, a feature and/or pattern recognition unit (RU) 435 configured to identify patterns and/or features in unstructured data sets. Specifically, in an embodiment, the OCR processor 430 is configured to identify at least characters in the unstructured data.

In an embodiment, the optical recognition processor 430 is configured to identify at least characters and other visual features in data and, in particular, in unstructured data. In an embodiment, the item identifier system 120 is configured to receive, via the network interface 440, an image (e.g., an image of expense receipts) or any other unstructured data set from, e.g., the user device 130. For example, a user of the user device 130 may take a picture of a receipt via a camera of the user device 130 and send the picture to the item identifier system 120. The unstructured data set is analyzed by the optical character recognition processor 430. The analysis may include, but is not limited to, recognizing elements shown in the unstructured data set via computer vision techniques. Such computer vision techniques may further include image recognition, pattern recognition, signal processing, character recognition, and the like.

Based on the identified characters and visual features, the optical recognition processor 430 is configured to identify item indicators of the electronic document. The item indicators may be utilized by the item identifier system 120 to, e.g., identify items of the electronic document, determine whether to submit a VAT reclaim request for the identified items, determine VAT values applied to purchases of the identified items, combinations thereof, and the like.

The storage 420 may also store metadata generated based on analyses of unstructured data by the OCR processor 430. In a further embodiment, the storage 420 may further store queries generated based on the metadata.

The network interface 440 allows the item identifier system 120 to communicate with the user device 130 and the web sources 140 to, for example, obtain images, retrieve information related to VATs and VAT reclaims, combinations thereof, and the like. Additionally, the network interface 440 allows the item identifier system 120 to communicate with the user device 130 in order to send notifications regarding verification of data, prompts for clarification or confirmation of information, and the like.

It should be understood that the embodiments described herein are not limited to the specific architecture illustrated in FIG. 4, and other architectures may be equally used without departing from the scope of the disclosed embodiments.

As used herein, the phrase “at least one of” followed by a listing of items means that any of the listed items can be utilized individually, or any combination of two or more of the listed items can be utilized. For example, if a step in a method is described as including “at least one of A, B, and C,” the step can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying items indicated in electronic documents, comprising:
obtaining an electronic document, the electronic document;
analyzing, via an optical recognition processor, the electronic document;
identifying, based on the optical recognition processor analysis, a plurality of item indicators of the electronic document; and
determining, based on the identified plurality of item indicators, at least one item indicated in the electronic document.

2. The method of claim 1, further comprising:
determining a type of each of the determined at least one item.

3. The method of claim 1, further comprising:
determining, based on the item identifiers and the determined items, a value-added tax (VAT) amount charged for each determined item.

4. The method of claim 3, wherein determining the VAT amount charged for each determined item further comprises:
querying at least one web source, wherein the VAT amount charged for each item is determined based on a response to the query.

5. The method of claim 1, further comprising:
determining, based on the item identifiers, whether each item is eligible for a value-added tax (VAT) reclaim.

6. The method of claim 5, further comprising:
automatically submitting a VAT reclaim request, when it is determined that at least one of the determined items is eligible for a VAT reclaim.

7. The method of claim 5, wherein determining whether each item is eligible for a VAT reclaim further comprises:
querying at least one web source, wherein the VAT eligibility for each item is determined based on a response to the query.

8. The method of claim 1, wherein the identified plurality of item indicators meets a predetermined threshold requirement.

9. The method of claim 1, wherein only item indicators sufficient to meet the predetermined threshold requirement are identified.

10. A non-transitory computer readable medium having stored thereon instructions for causing one or more processing units to execute a method, the method comprising:
obtaining an electronic document, the electronic document including a plurality of item indicators;
analyzing, via an optical recognition processor, the electronic document;
identifying, based on the optical recognition processor analysis, the plurality of item indicators; and
determining, based on the identified plurality of item indicators, at least one item indicated in the electronic document.

11. A system for identifying items indicated in electronic documents, comprising:
an optical recognition processor;
a processing circuitry; and
a memory, the memory containing instructions that, when executed by the processing circuitry, configure the system to:
obtain an electronic document, the electronic document including a plurality of item indicators;
analyze, via the optical recognition processor, the electronic document;
identify, based on the optical recognition processor analysis, the plurality of item indicators; and
determine, based on the identified plurality of item indicators, at least one item indicated in the electronic document.

12. The system of claim 11, wherein the system is further configured to:
determine a type of each of the determined at least one item.

13. The system of claim 11, wherein the system is further configured to:
determine, based on the item identifiers and the determined items, a value-added tax (VAT) amount charged for each determined item.

14. The system of claim 13, wherein the system is further configured to:
query at least one web source, wherein the VAT amount charged for each item is determined based on a response to the query.

15. The system of claim 11, wherein the system is further configured to:
determine, based on the item identifiers, whether each item is eligible for a value-added tax (VAT) reclaim.

16. The system of claim 15, wherein the system is further configured to:
automatically submit a VAT reclaim request, when it is determined that at least one of the determined items is eligible for a VAT reclaim.

17. The system of claim 15, wherein the system is further configured to:
query at least one web source, wherein the VAT eligibility for each item is determined based on a response to the query.

18. The system of claim 11, wherein the identified plurality of item indicators meets a predetermined threshold requirement.

19. The system of claim 11, wherein only item indicators sufficient to meet the predetermined threshold requirement are identified.
